(19) United States
(12) Patent Application Publication
(10) Pub. No.: US 2018/0187759 A1
(43) Pub. Date: Jul. 5, 2018

(54) HEAVY DUTY ELECTRO-MECHANICAL LINEAR ACTUATOR

(71) Applicant: Thomson Linear LLC, Marengo, IL (US)

(72) Inventors: Anthony Smith, Machesney Park, IL (US); Chris Jones, Geneva, IL (US); Rikard Henrysson, Ahus (SE); Tony Giannetto, Centereach, NY (US); Pete Castelli, Patchogue, NY (US); Norman Dickey, Rockton, IL (US); Don Alfano, Roscoe, IL (US)

(21) Appl. No.: 15/863,254

(22) Filed: Jan. 5, 2018

Related U.S. Application Data
(60) Provisional application No. 62/442,867, filed on Jan. 5, 2017.

(51) Int. Cl. F16H 25/20; F16H 25/24; F16H 25/22; F16H 57/029

(52) U.S. Cl. CPC F16H 25/2015; F16H 25/2454; F16H 2057/02034; F16H 57/029; F16H 2025/2031; F16H 25/2219

(57) ABSTRACT

A linear actuator includes a rotatable motor shaft. A gear package engages the shaft and a lead screw engages the gear package such that rotation of the shaft results in rotation of the lead screw. A nut cooperates with the lead screw and with the extrusion housing such that rotation of the output shaft causes axial travel of the nut. An output coupling cooperates with the nut such that axial travel of the nut causes axial travel of the output coupling. A control system is disposed internal to the housing and includes a controller, a plurality of feedback components and a communications network. The controller receives input data from external sources via the communications network and receives operational data from the feedback components. The controller controls the motor based on comparisons of the input data from the external sources and the operational data from the feedback components.

### CROSS-REFERENCE TO RELATED APPLICATIONS

This application claims the benefit of U.S. Provisional Application No. 62/442,867 filed Jan. 5, 2017, the disclosure of which is incorporated herein by reference.

### BACKGROUND

An electro-mechanical linear actuator is a device that is used to generate axial movement of a workpiece along a desired path of movement. A typical electro-mechanical linear actuator includes an electric motor having a rotatable output shaft. The output shaft of the electric motor is connected through a gear train to a ball nut and ball-type lead screw mechanism. Rotation of the output shaft of the electric motor causes corresponding rotation of the ball-type lead screw. The ball nut is mounted on the ball type lead screw in such a manner as to be restrained from rotating with the ball-type lead screw when the ball-type lead screw rotates. As a result, rotation of the ball-type lead screw causes linear movement of the ball nut in an axial direction along the ball-type lead screw. The direction of such axial movement of the ball nut (and the workpiece connected thereto) is dependent upon the direction of rotation of the ball-type lead screw.

Electro-mechanical linear actuators are widely used in a variety of applications ranging from small to heavy loads. To meet the task at hand, electro-mechanical linear actuators come in all sizes; generally with larger, heavier electro-mechanical linear actuators handling large loads, and smaller, lighter electro-mechanical linear actuators handling small loads.

In certain applications, electro-mechanical linear actuators are required to be of a certain size and operate under environmentally challenging conditions, such as when being splashed by salt spray. Unfortunately, electro-mechanical linear actuators can suffer from high component costs and long development times when implemented in such an application. Furthermore, electro-mechanical linear actuators that are designed for such use are either relatively large, lack useful features, are unable to sustain performance in harsh conditions for long periods of time, or are unable to operate at the desired performance level as required by a customer.

It would be desirable to provide an improved electro-mechanical linear actuator, with increased durability and more useful features, all while reducing the overall footprint of the electro-mechanical linear actuator.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the heavy-duty electro-mechanical linear actuator.

The above objects as well as other objects not specifically enumerated are achieved by a linear actuator. The linear actuator includes a housing formed by a front housing, a rear housing and an extrusion housing. A motor is supported within the front and rear housings and includes a rotatable output shaft. A gear package is configured to engage the output shaft of the motor such that rotation of the output shaft results in rotation of portions of the gear package. A lead screw is configured to engage the gear package such that rotation of portions of the gear package results in rotation of the lead screw. The lead screw has an external thread. A nut is configured to cooperate with the external thread of the lead screw. The nut further cooperates with the extrusion housing such that rotation of the output shaft of the motor causes travel in an axial direction of the nut relative to the extrusion housing. An output coupling is configured to cooperate with the nut such that travel in an axial direction of the nut causes corresponding travel in an axial direction of the output coupling and a control system is disposed internal to the housing. The control system includes a controller, a plurality of feedback components and a communications network. The controller is configured to receive input data from external sources via the communications network and also configured to receive operational data from the plurality of feedback components. The controller is further configured to control the motor based on comparisons of the input data from the external sources and the operational data from the plurality of feedback components.

Various aspects of the heavy-duty electro-mechanical linear actuator will become apparent to those skilled in the art from the following detailed description of the illustrated embodiments, when read in light of the accompanying drawings.

### BRIEF DESCRIPTION OF THE DRAWINGS

FIG. 1A is a perspective view of a heavy-duty electro-mechanical linear actuator, shown in a retracted arrangement.

FIG. 1B is a perspective view of the heavy-duty electro-mechanical linear actuator of FIG. 1A, shown in an extended arrangement.

FIG. 1C is an exploded perspective view of a portion of the heavy-duty electro-mechanical linear actuator of FIG. 1A.

FIG. 1D is a perspective view of a first side of a printed circuit board of the heavy-duty electro-mechanical linear actuator of FIG. 1A.

FIG. 1E is a perspective view of a second side of a printed circuit board of the heavy-duty electro-mechanical linear actuator of FIG. 1A.

FIG. 2A is an exploded perspective view of a brake assembly of the heavy-duty electro-mechanical linear actuator of FIG. 1C.

FIG. 2B is a perspective view of a C-hub of the brake assembly of FIG. 2A.

FIG. 3 is an exploded perspective view of a portion of the heavy-duty electro-mechanical linear actuator of FIG. 1A.

FIG. 4 is an exploded perspective view of a portion of the heavy-duty electro-mechanical linear actuator of FIG. 1A.

FIG. 5A is an exploded perspective view of a portion of the heavy-duty electro-mechanical linear actuator of FIG. 1A.

FIG. 5B is a perspective view of a ball nut of the heavy-duty electro-mechanical linear actuator from FIG. 1A.

FIG. 6 is a cross-sectional schematic diagram of the heavy-duty electro-mechanical linear actuator of FIG. 1A.

FIG. 7 is a flow chart schematic of the operation of a control system of the heavy-duty electro-mechanical linear actuator of FIG. 1A.

### DETAILED DESCRIPTION

The heavy-duty electro-mechanical linear actuator will now be described with occasional reference to specific embodiments. The heavy-duty electro-mechanical linear actuator may, however, be embodied in different forms and should not be construed as limited to the embodiments set forth herein. Rather, these embodiments are provided so that this disclosure will be thorough and complete, and will fully convey the scope of the heavy-duty electro-mechanical linear actuator to those skilled in the art.

Unless otherwise defined, all technical and scientific terms used herein have the same meaning as commonly understood by one of ordinary skill in the art to which the heavy-duty electro-mechanical linear actuator belongs. The terminology used in the description of the heavy-duty electro-mechanical linear actuator is for describing particular embodiments only and is not intended to be limiting of the heavy-duty electro-mechanical linear actuator. As used in the description of the heavy-duty electro-mechanical linear actuator and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in the embodiments of the heavy-duty electro-mechanical linear actuator.

Notwithstanding that the numerical ranges and parameters setting forth the broad scope of the heavy-duty electro-mechanical linear actuator are approximations, the numerical values set forth in the specific examples are reported as precisely as possible. Any numerical values, however, inherently contain certain errors necessarily resulting from error found in their respective measurements.

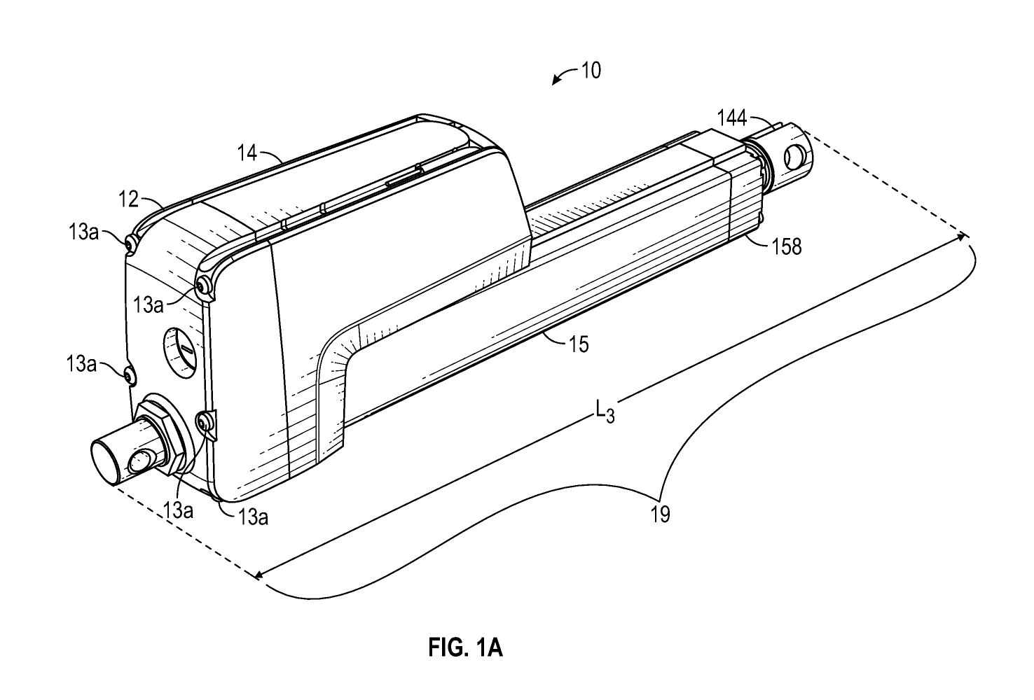

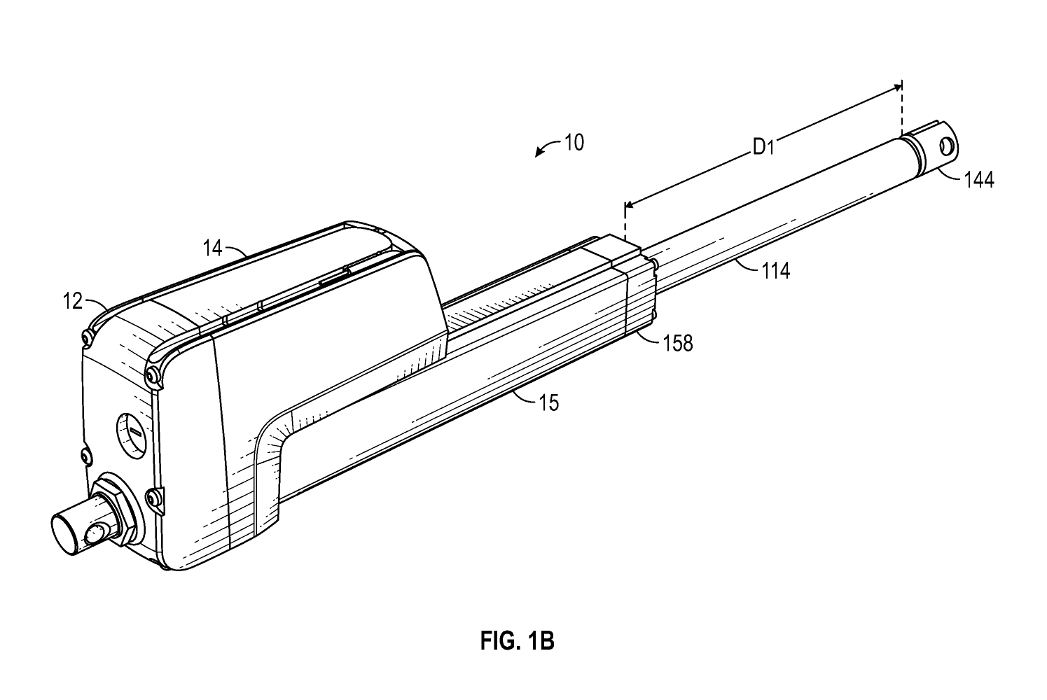

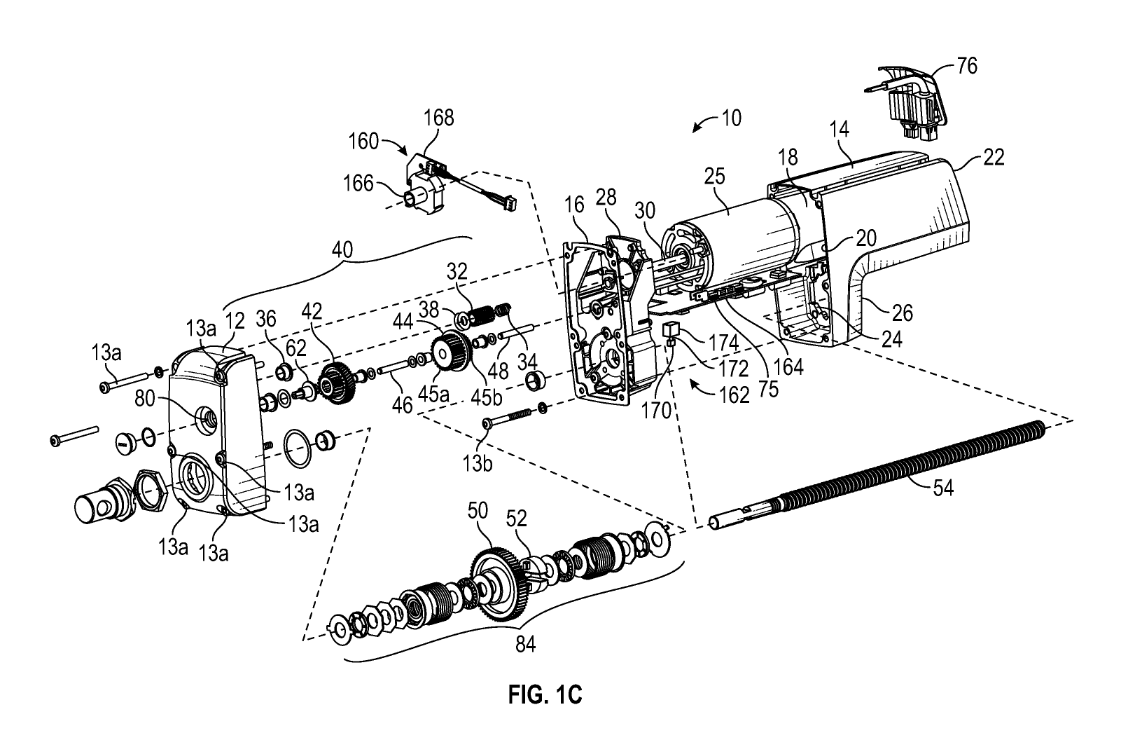

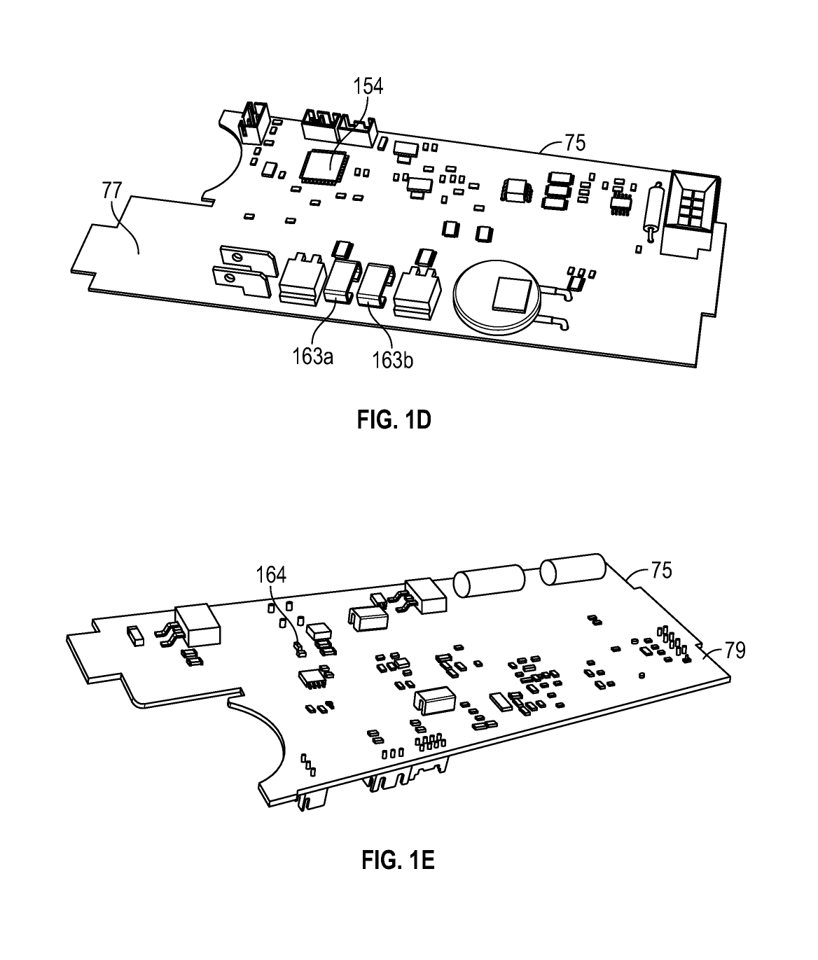

Referring now to the drawings, there is illustrated in FIG. 1A a heavy-duty electro-mechanical linear actuator 10 (hereafter “linear actuator”). Generally, the linear actuator 10 is capable of handling large loads, is cost effective and suitable for use in applications where space is limited. The linear actuator 10 is configured to receive an electrical current input and provide an axial output.

Referring again to FIG. 1A, the linear actuator 10 includes a rear housing 12, a front housing 14, an extrusion housing 15 and an output coupling 144. Collectively, the rear housing 12, front housing 14 and extrusion housing 15 are referred to as a housing 19. In the embodiment shown in FIG. 1A, the output coupling 144 is shown in a retracted orientation. That is, the output coupling 144 is positioned in close proximity to an outboard end 158 of the extrusion housing 15. The rear housing 12, front housing 14, and extrusion housing 15 are configured to protect and support various internal components. The rear housing 12 is coupled to the front housing 14 by a first plurality of fasteners 13a, while the extrusion housing 15 is coupled to the front housing 14 via a second plurality of fasteners 13b as shown in FIG. 1C. However, it will be appreciated that in other embodiments, the rear housing 12, the front housing 14, and the extrusion housing 15 can be coupled together with other structures, mechanisms, and devices sufficient to perform the functions described herein.

Referring now to FIG. 1B, the linear actuator 10 is again illustrated. In the embodiment shown in FIG. 1B, the output coupling 144 is shown in an extended orientation. That is, the output coupling 144 is positioned a distance D₁ apart from the outboard end 158 of the extrusion housing 15. In the illustrated embodiment, the distance D₁ is in a range of from about 0.1 meters to about 1.0 meters. However, in other embodiments, the distance D₁ can be less than about 0.1 meters or more than about 1.0 meters. Advantageously, the linear actuator 10 is configured to provide the maximum distance D₁ while also providing a high thrust rating of 16.0 kilonewtons (kN).

Referring now to FIG. 1C, a portion of the linear actuator 10 is illustrated in an exploded view. A gasket 16 is disposed between the rear housing 12 and the front housing 14. The gasket 16 is configured to provide a seal between the rear housing 12 and the front housing 14. The gasket 16 can be made out of a polymeric material, or a combination of polymeric materials, with compression features, such as the non-limiting examples of polyurethane or polypropylene. When the rear housing 12 is assembled to the front housing 14, the gasket 16 is configured to compress, thereby forming a seal between the rear housing 12 and the front housing 14. It will be appreciated that the gasket 16 could be made out of any suitable material, or combinations of materials, sufficient to provide a seal between the rear housing 12 and the front housing 14. The gasket 16 is further held in place by the first plurality of fasteners 13a.

Referring again to FIG. 1C, the front housing 14 includes a first cavity 18 formed therein. The first cavity 18 extends from an opening 20 to an opposing wall 22. The first cavity 18 is configured to receive a motor 25 and a printed circuit board 75. The motor 25 and the printed circuit board 75 will be further discussed below. The front housing 14 further includes a second cavity 24 formed therein. The second cavity 24 extends from the opening 20 to an opposing wall 26. Portions of the cavities 18 and 24 overlap, thereby allowing the cavities 18 and 24 to receive a support member 28. The support member 28 is configured to cooperate with the rear housing 12 and front housing 14 to support the various internal components of the linear actuator 10.

Referring again to FIG. 1C, the motor 25 is fixed to the support member 28 by the one or more fasteners (not shown). The motor 25 is configured to urge rotation of a motor shaft 30. The motor shaft 30 has a length that is longer than conventional motor shafts, such as to be fitted with pulse counting mechanisms. In the illustrated embodiment, the motor shaft 30 is longer than conventional motor shafts by a distance in a range of from about 0.75 inches to about 2.0 inches. In alternate embodiments, the motor shaft 30 can be longer than conventional motor shafts by a distance less than about 0.75 inches or more than about 2.0 inches, sufficient to be fitted with pulse counting mechanisms.

Referring again to FIG. 1C, a motor gear 32 is mounted on the motor shaft 30, such that rotation of the motor shaft 30 results in rotation of the motor gear 32. A spring 34 is disposed on the motor shaft 30 between the motor 25 and the motor gear 32. The spring 34 is configured to eliminate axial end play of the motor gear 32, thereby reducing noise.

Referring again to FIG. 1C, the rear housing 12 includes an opening (not shown) configured to receive a motor shaft bushing 36. The motor shaft bushing 36 is configured to receive a distal end of the motor shaft 30. A shim 38 is disposed on the motor shaft 30 between the motor gear 32 and the motor shaft bushing 36 and is configured to provide a low friction surface for the rotation of the motor gear 32.

Referring again to FIG. 1C, a gear package 40 is illustrated. The gear package 40 includes a first cluster gear 42 and a second cluster gear 44. The first cluster gear 42 is supported by a first gear axle 46 that is configured to extend between the rear housing 12 and support member 28. The second cluster gear 44 includes a first side 45a and a second side 45b. The second cluster gear 44 is supported by a second gear axle 48, configured to extend between the rear housing 12 and the support member 28. The gear package 40 further includes a drive gear 50 and a C-hub 52. The drive gear 50 and the C-hub 52 are both supported by a ball-type lead screw 54 and will be further discussed below.

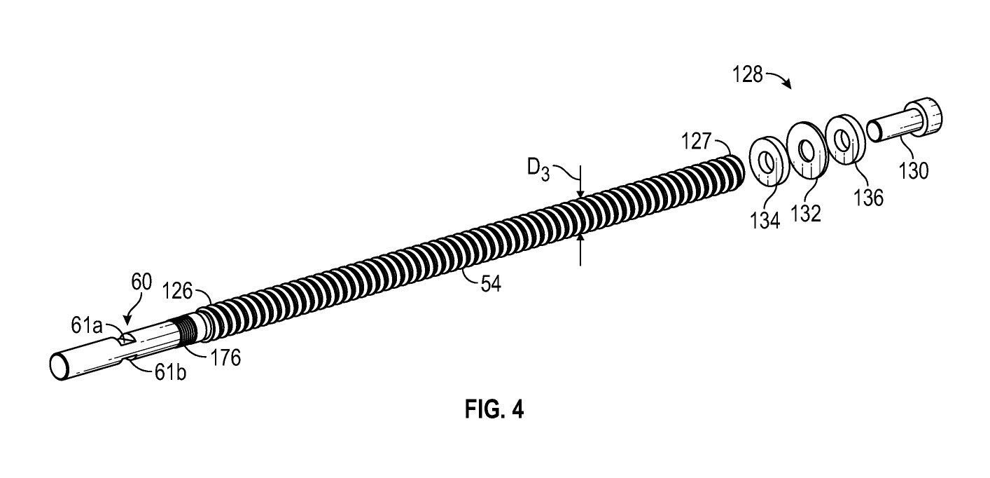

Referring now to FIGS. 1C and 4, the gear package 40 is configured to transmit torque from the motor shaft 30 to the lead screw 54. In the illustrated embodiment, the lead screw 54 is a ball-type lead screw, as is conventional in the art. However, it should be appreciated that in other embodiments, the lead screw 54 can have other forms sufficient to perform the functions described herein. The first cluster gear 42 is configured to engage the motor gear 32, thereby transferring torque from the motor gear 32 to the first cluster gear 42. The second cluster gear 44 is configured to engage the first cluster gear 42, thereby transferring torque from the first cluster gear 42 to the second cluster gear 44. The drive gear 50 is configured to engage the second cluster gear 44, thereby transferring torque from the second cluster gear 44 to the drive gear 50. The drive gear 50 is configured to engage the C-Hub 52, thereby transferring torque from the drive gear 50 to the C-Hub 52. Finally, the C-Hub 52 is configured to engage the lead screw 54, thereby transferring torque from the C-Hub 52 to the lead screw 54. The engagements of the drive gear 50, C-Hub 52, and lead screw 54 will be further discussed below.

Referring again to FIG. 1C, a manual override drive 62 is illustrated. The manual override drive 62 is configured to permit a customer to manually adjust the rotation of the lead screw 54 (see FIG. 4). The manual override drive 62 extends from an aperture 80 disposed in the rear housing 12 and engages the first cluster gear 42. In operation, a tool (not shown), such as the non-limiting example of a socket wrench, can engage the manual override drive 62 through the aperture 80 sufficient to manually adjust the rotation of the lead screw 54 (see FIG. 4). It will be appreciated that in other embodiments, the linear actuator 10 could have other structures, mechanisms, or devices sufficient to permit the customer to manually adjust the rotation of the lead screw 54.

Referring again to FIG. 1C, the printed circuit board 75 is supported by the support member 28 and disposed within the first cavity 20 of the front housing 14, adjacent to the motor 25. The printed circuit board 75 is configured to control the motor 25 and will be further discussed below. Additionally, a cable harness assembly 76 is attached to the front housing 14. The cable harness assembly 76 is configured to provide electrical connections to the motor 25 and to the printed circuit board 75 in a watertight arrangement. The printed circuit board 75 will be further discussed below.

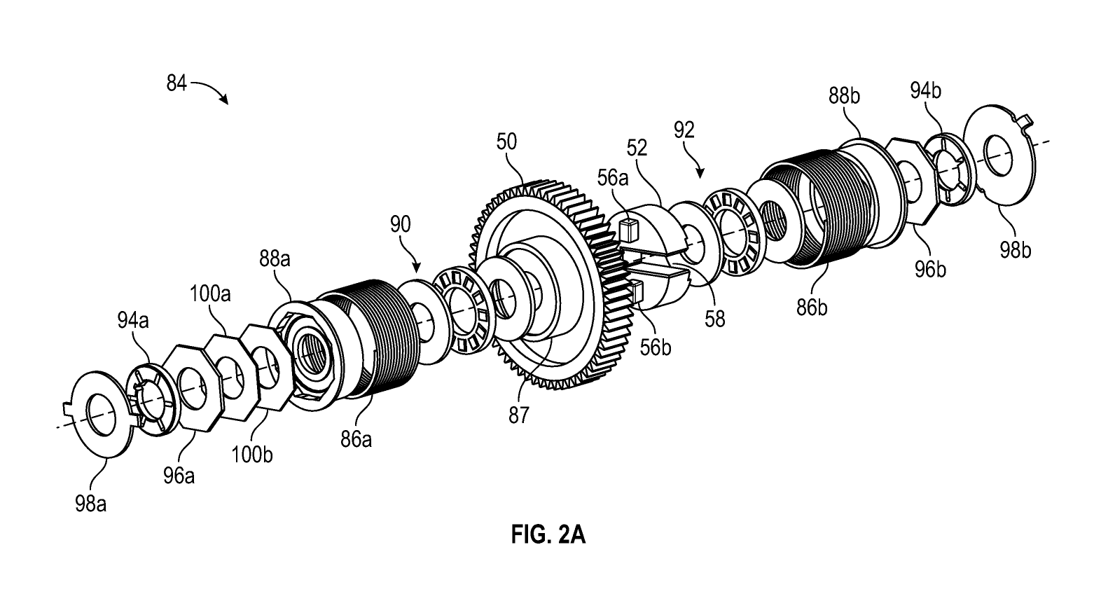

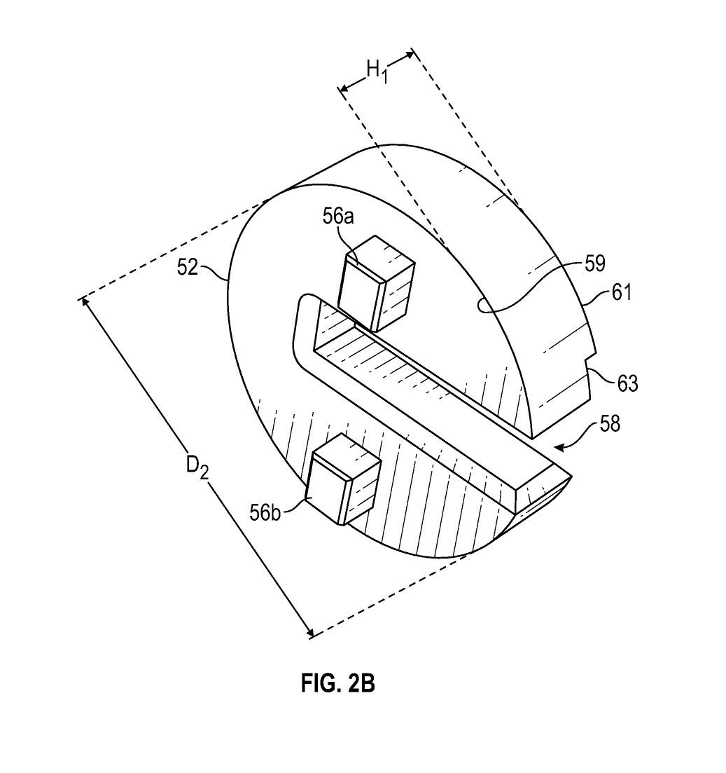

Referring now to FIGS. 1C and 2A, a brake assembly 84 for use in the linear actuator 10 is illustrated. The brake assembly 84 is configured to prevent undesirable back driving of the lead screw 54 (see FIG. 4) when the linear actuator 10 is experiencing a resistive or a compression load, while the power to the motor is in an off orientation. The brake assembly 84 is supported by the lead screw 54, which extends therethrough as shown in FIG. 4. The brake assembly 84 includes the drive gear 50 and the C-hub 52 discussed above. The brake assembly 84 further includes two wrap springs 86a and 86b. The wrap spring 86a is configured to be supported by a hub 87 that is integral with the drive gear 50, while the wrap spring 86b is configured to be supported by the C-hub 52, which is attached to the drive gear 50. Two additional hubs 88a and 88b are received within the outer ends of the wrap springs 86a and 86b. The wrap springs 86a and 86b are configured to provide friction when driven in the direction that causes the wrap springs 86a and 86b to tighten around respective hubs 52, 87, 88a and 88b.

Referring again to FIG. 2A, a bearing assembly 90 is disposed within the wrap spring 86a between the hub 88a and the hub 87. A second bearing assembly 92 is disposed within the wrap spring 86b, between the C-hub 52 and the hub 88b. The first and second bearings 90 and 92 are configured to reduce rotational friction when the brake assembly 84 is disengaged.

Referring again to FIG. 2A, two friction discs 94a and 94b are configured to provide friction surfaces when clamped between finger washers 98a and 98b and octagon washers 96a and 96b. The finger washers 98a and 98b are configured to resist the rotation urged by the lead screw 54, thereby providing non-rotating friction surfaces for the friction discs 94a and 94b. In the illustrated embodiment, two shims 100a and 100b are included to reduce excess axial play, however, it will be appreciated any number of shims may be used to reduce excess axial play, including zero shims if no excess axial play is present.

Referring again to FIG. 2A, when the linear actuator 10 extends under a compression load the wrap spring 86a slips on hub 88a, and the drive gear 50 turns the lead screw 54 (see FIG. 4) through bearing 90. When the motor 25 is off, compressive loads urge the lead screw 54 (see FIG. 4) to back-drive. When this occurs, the wrap spring 86a couples the hubs 87 and 88a together, such that continued back driving of the lead screw 54 (see FIG. 4) would require the rotation of the friction disc 94a. However, the torque of friction from the friction disc 94a is greater than the torque of the compression load, thus the position of the lead screw 54 is maintained. It will be appreciated that the related components to those described above, such as wrap spring 86b, friction disc 94b, hub 88b, and etc. all function substantially in the same way, thus they will not be individually described. It will also be appreciated that although brake assembly 84 is illustrated, in other embodiments other structures, mechanisms or devices sufficient to prevent undesirable back driving of the lead screw 54 may be used.

Referring now to FIG. 2B, the C-Hub 52 is illustrated. The C-Hub 52 is configured to transmit torque from the drive gear 50 to the lead screw 54. The C-Hub 52 is cast from a metallic material or a combination of metallic materials such as to be sufficiently hard to resist deformation. It will be appreciated that in other embodiments the C-Hub 52 can be formed from other materials, or combination of materials, sufficient to resist deformation.

Referring again to FIG. 2B, the C-Hub 52 generally has a substantially circular cross-sectional profile sufficient to be retained within the interior spaces of a wire spring 86b. The C-Hub 52 has a diameter D₂ in a range of from about 31.0 millimeters to about 35.0 millimeters and a height H₁ in a range of from about 8.0 millimeters to about 12.0 millimeters. However, it should be appreciated that the C-Hub 52 can have other cross-sectional profiles, diameters and other heights sufficient to be retained within the interior spaces of a wire spring 86b.

Referring again to FIG. 2B, the C-Hub 52 includes protrusions 56a and 56b disposed on and extending from a first side 59 of the C-Hub 52. The protrusions 56a, 56b are configured to be received by corresponding recesses (not shown) disposed within the drive gear 50, such that rotation of the drive gear 50 (see FIGS. 1C and 2A) results in rotation of the C-hub 52. The protrusions 56a and 56b and the recesses have a close tolerance fit therebetween, but not an interference fit. In the illustrated embodiment the protrusions 56a and 56b and the C-Hub 52 form a unitary body, however, in other embodiments the C-Hub 52 and the protrusions 56a and 56b may be separate, discrete elements that are affixed to the drive gear 50. In the illustrated embodiment, the protrusions 56a and 56b have a substantially rectangular cross-sectional shape and are substantially similar to each other. However, in other embodiments, the protrusions 56a and 56, can have other cross-sectional shapes and can be different from each other sufficient that the protrusions can be received by corresponding recesses (not shown) disposed within the drive gear 50. Although in the illustrated embodiment, the C-Hub 52 connects to the drive gear 50 via the structure of recesses and protrusions 56a and 56b, it will be appreciated that in other embodiments the C-Hub 52 and drive gear 50 may include other structures, mechanisms, and devices sufficient to connect the C-hub 52 and the drive gear 50, such that rotation of the drive gear 50 will result in rotation of the C-Hub 52.

Referring again to FIG. 2B, the C-Hub 52 further includes a slot 58 formed therein. The slot 58 is configured to receive a mating drive feature 60 of the lead screw 54 (see FIG. 4), such that rotation of the C-hub 52 results in rotation of the lead screw 54. The slot 58 and the mating drive feature 60 of the lead screw 54 have a close tolerance fit therebetween, but not an interference fit. The illustrated structure of the slot 58 receiving the mating drive feature 60 of the lead screw advantageously substantially reduces the risk undesirable bending of the lead screw 54 (see FIG. 4) associated with conventional drive methods, such as press fitting. The undesirable bending of the lead screw 54 (see FIG. 4) results in unwanted wobble and noise.

Referring again to FIGS. 2B and 4, the slot 58 extends through both the first side 59 and a second side 61 of the C-Hub 52. The slot 58 is defined by a rectangular cross-sectional shape, corresponding to the rectangular cross-sectional shape of the mating drive feature 60 of the lead screw 54. Alternatively, it will be appreciated that in other embodiments, the slot 58 of the C-Hub 52 and the mating drive feature 60 of the lead screw 54 may have different cross-sectional shapes, sufficient to facilitate the engagement of the C-Hub 52 with the lead screw 54.

Referring again to FIG. 2B, the second side 61 of the C-Hub 52 further includes a recess 63 formed thereon. The recess 63 is configured to retain a portion of the second bearing assembly 92 (see FIG. 2A). The recess 63 can have any desired shape, depth and configuration sufficient to retain a portion of the second bearing assembly 92.

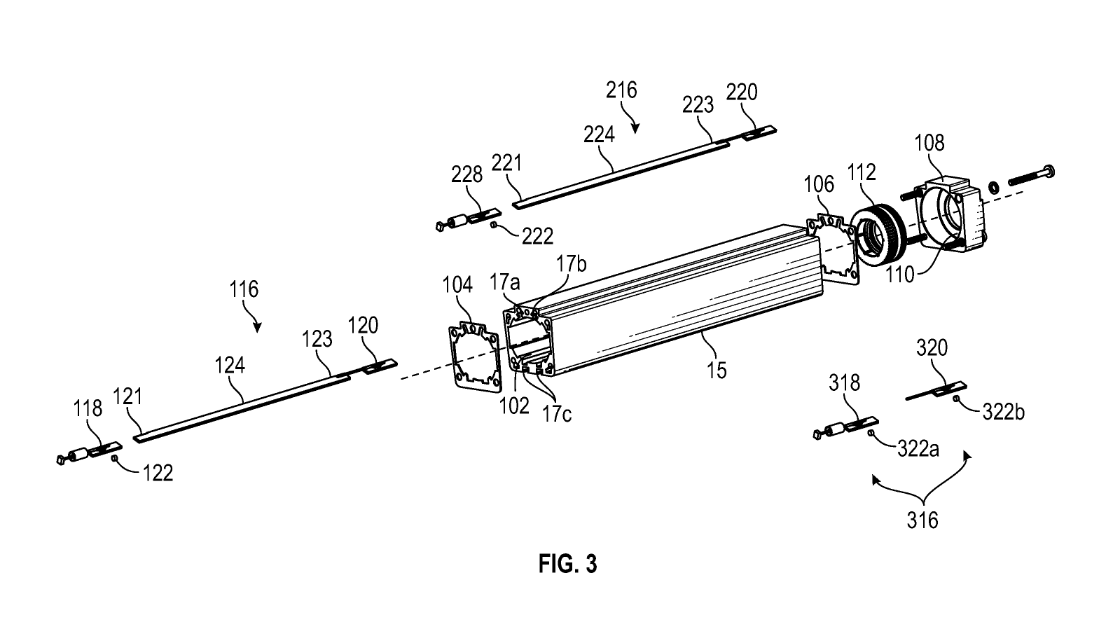

Referring now to FIG. 3, the extrusion housing 15 and related components are further illustrated. The extrusion housing 15 includes a cavity 102 formed therethrough. The extrusion housing 15 is configured to support various components, while the cavity 102 is configured to receive various components. The extrusion housing 15 includes first and second internal grooves 17a and 17b and one or more external grooves 17c. The grooves 17a-17c extend longitudinally along the length of the extrusion housing 15. The grooves 17a-17c will be discussed below.

Referring again to FIG. 3, a gasket 104 is disposed between the extrusion housing 15 and the wall 26 of the front housing 14 (see FIGS. 1A, 1B, and 1C). The gasket 104 is configured to seal a joint formed by the extrusion housing 15 and the wall 26 (see FIGS. 1A, 1B, and 1C). In the illustrated embodiment, the gasket 104 is formed from polymeric materials with compression features, or combinations of polymeric materials with compression features, such as the non-limiting examples of polyurethane or polypropylene. However, in other embodiments, the gasket 104 can be formed from other materials with compression features, suitable to seal the joint formed by the extrusion housing 15 and the wall 26.

Referring again to FIGS. 1C and 3, the fasteners 13b extend through the support member 28 and wall 26 of the front housing 14, through the gasket 104 and into the extrusion housing 15, thereby retaining the extrusion housing 15 to the front housing 14.

Referring again to FIG. 3, a second gasket 106 is disposed between the extrusion housing 15 and an extrusion cover 108. The gasket 106 is configured to form a seal at the joint formed by the extrusion housing 15 and the extrusion cover 108. In the illustrated embodiment, the gasket 106 is formed from the same materials as the gasket 104. Alternatively, the gasket 106 can be formed from other materials suitable to form a seal at the joint formed by the extrusion housing 15 and the extrusion cover 108.

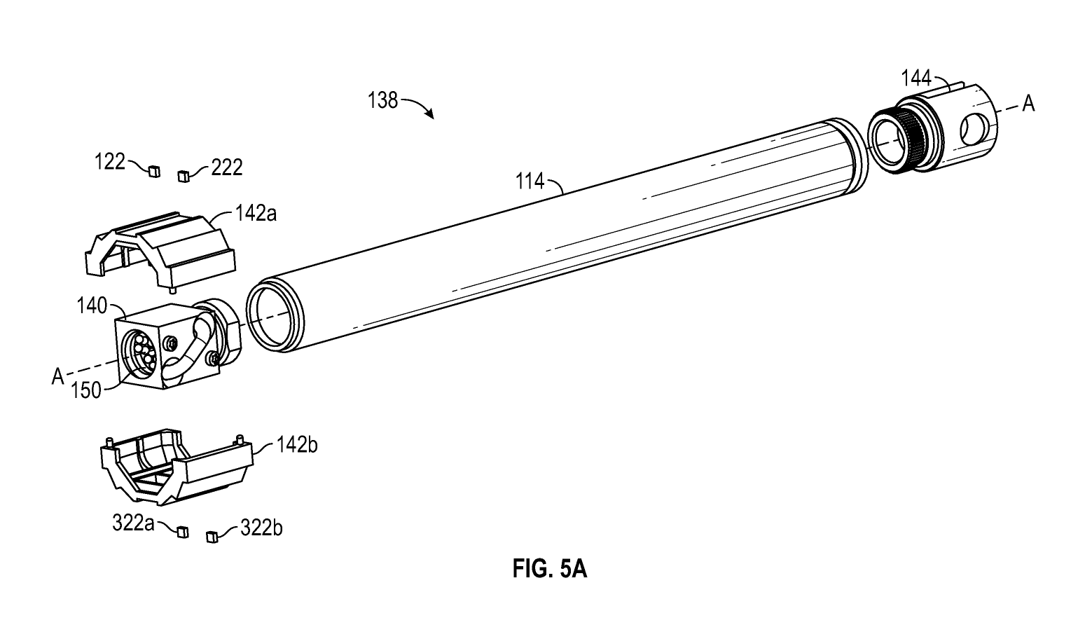

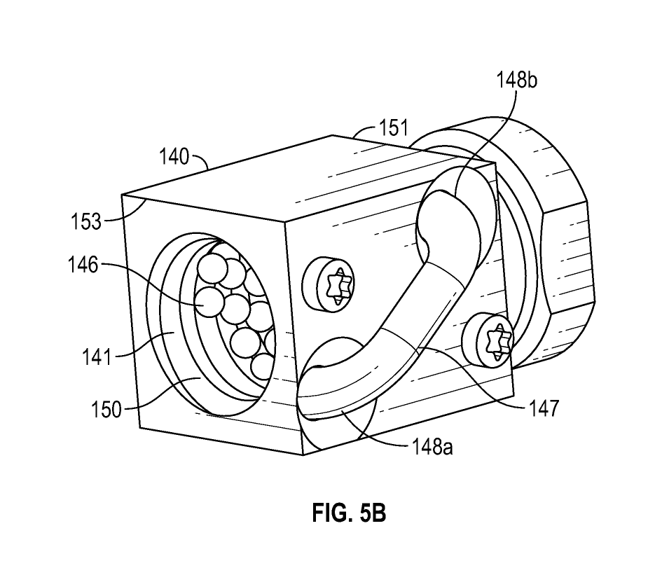

Referring again to FIG. 3, the extrusion cover 108 includes a cavity 110 formed therein. A support assembly 112 is disposed within the cavity 110. The support assembly 112 is configured to support and seal an extension tube 114 (see FIG. 5A), which will be described below and illustrated in FIG. 5A.

Referring again to FIG. 3, a first limit system 116 is illustrated. The first limit system 116 is configured to be disposed within the first internal groove 17a. The first limit system 116 includes a first magnetic reed switch 118, a second magnetic reed switch 120, and sensor magnet 122. The first magnetic reed switch 118 is disposed on a first end 121 of a spacer 124, while the second magnetic reed switch 120 is disposed at the second end 123 of the spacer 124. The spacer 124 is sized in accordance with a desired linear actuator stroke length. The first limit system 116 is configured to provide positional signals. The first limit system 116 will be further described below.

Referring again to FIG. 3, a second limit system 216 is illustrated. The second limit system 216 is configured for placement within the second internal groove 17b. The second limit system 216 is configured to provide redundant positional feedback signals. In the illustrated embodiment, the second limit system 216 is the same as, or similar to the first limit system 116. However, in other embodiments, the second limit system 216 can be different from the first limit system 116, sufficient to provide redundant positional feedback signals.

Referring again to FIG. 3, a third limit system 316 is illustrated. The third limit system 316 is configured for disposition within the exterior groove 17c. The third limit system 316 is configured to provide adjustable positional data, meaning reed switches 318 and 320 may be disposed within the exterior groove 17c at positions as desired by the customer, thereby providing adjustable position feedback. While the third limit system 316 is shown in FIG. 3 as having the reed switches 318 and 320, it should be appreciated that in other embodiments, the third limit system 316 can have other desired assemblies, components and/or structure sufficient to provide adjustable positional data.

Referring now to FIG. 4, the lead screw 54 of the linear actuator 10 is illustrated. The lead screw 54 has a diameter D₃ sufficient that the lead screw 54 can be extended a distance of up to 1.0 meters without substantial deflection. In the illustrated embodiment, the diameter D₃ of the lead screw 54 is in a range of from about 13.0 millimeters to about 19.5 millimeters. It will be appreciated that in other embodiments, the lead screw 54 can have other diameters D₃ sufficient for the functions described herein.

Referring again to FIG. 4, the lead screw 54 includes the mating drive feature 60 and an outer circumferential surface 126 that includes ball screw threads. The term “ball screw threads”, as used herein, is defined to mean the threads have a cross-sectional profile sufficient to receive a portion of a ball. The mating drive feature 60 includes a first indentation 61a and a second opposing indentation 61b disposed on the outer circumferential surface 126 of the lead screw 54. The first and second indentations 61a and 61b are configured for insertion into the slot 58 formed within the C-Hub 52. However, it will be appreciated that in other embodiments, the lead screw 54 may include other mechanisms, structures, or devices configured to cooperate with the C-Hub 52.

Referring again to FIG. 4, an end stop assembly 128 extends from, and is attached to, a distal end 127 of the lead screw 54. The end stop assembly 128 will be discussed further below. The lead screw 54 further includes a second threaded portion 176, which will also be further discussed below.

Referring now to FIG. 5A, an output assembly 138 is illustrated. The output assembly 138 includes the extension tube 114, a ball nut 140, opposing guide elements 142a and 142b, and the output coupling 144. The output assembly 138 is configured to convert the rotational torque of the lead screw 54 into a linear thrust generated by the ball nut 140 and transfer the linear thrust to the output coupling 144. The linear thrust transferred to the output coupling 144 is configured to, in turn, cause linear movement of a workpiece (not shown). The ball nut 140 includes a cavity 148 formed therethrough with an inner circumferential wall 150. The inner circumferential wall 150 includes spirally-shaped ball races 141 configured to generally align with the ball screw threads formed on the outside circumferential surface 126 of the lead screw 54 (see FIG. 4). While the output coupling 144 has the shape, size and configuration as shown in FIG. 5A, it should be appreciated that in other embodiments, the output coupling 144 can have other shape, size and configurations sufficient to cause linear movement of a workpiece.

Referring again to FIG. 5A, sensor magnets 322a and 322b of the third limit system 316 (see FIG. 3) are attached to the guide element 142b. The sensor magnet 122 of the first limit system 116 and sensor magnet 222 of the second limit system 216 (see FIG. 3) are also attached to guide element 142a.

Referring now to FIG. 5B, the ball nut 140 is illustrated, including a plurality of metallic balls 146. The plurality of metallic balls 146 are configured to be partially received by both the ball races 141 disposed on the inner circumferential wall 150 of the ball nut 140 and the ball screw threads on the outer circumferential surface 126 of the lead screw 54 (see FIG. 4), thereby resulting in the engagement of the lead screw 54 and the ball nut 140 through the plurality of metallic balls 146. The metallic balls 146 are configured to reduce friction and substantially eliminate undesirable backlash. In the illustrated embodiment, the metallic balls 146 have a diameter in a range of from about 1.0 millimeter to about 3.0 millimeters. However, it will be appreciated that in other embodiments the balls 146 may have other diameters sufficient to accomplish the functions described herein.

Referring again to FIG. 5B, the ball nut 140 includes a hollow ball return tube 147. The ball return tube 147 is configured to receive the metallic balls 146 from one end of the ball nut 140 and convey the metallic balls 146 to an opposite end of the ball nut 140, thereby facilitating recycling of the metallic balls 146 during rotation of the lead screw 54.

Referring again to FIG. 5B, the ball return tube 147 includes a first end 148a and a second end 148b. The first and second ends 148a and 148b and are configured to align with the ball race 141 such that the metallic balls 146 can seamlessly enter into ball return tube 147 from the ball race 141 and enter into the balls race 141 from the ball return tube 147.

In the illustrated embodiment, a single ball return tube 147 is illustrated. However, it will be appreciated that in other embodiments any desired number of ball return tubes 147 may be included sufficient to accomplish the tasks described herein.

Referring now to FIGS. 3 and 5A, the ball nut 140 is disposed within the opposing guide elements 142a and 142b. The guide elements 142a and 142b are disposed within the cavity 102 of the extension housing 15. The guide elements 142a and 142b engage the ball nut 140 and slidably engage corresponding interior surfaces of the extension housing 15, such as to prevent the ball nut 140 from rotating as the ball nut 140 travels in an axial direction along the lead screw 54 (see FIG. 4), as shown by axis A. Furthermore, the guide elements 142a and 142b are configured with a close tolerance with the extension housing 15 to minimize radial movement (wobble) of the output coupling 144. The guide elements 142a and 142b can have any desired form and structure sufficient to engage the ball nut 140 and corresponding interior surfaces of the extension housing 15 such as to prevent the ball nut 140 from rotating as the ball nut 140 travels in an axial direction along the lead screw 54 (see FIG. 4).

Referring now to FIG. 5A, the extension tube 114 includes a cavity 152 formed therethrough. The cavity 152 is configured to receive the lead screw 54 (see FIG. 4) for extension therethrough without engagement. The extension tube 114 is attached to the ball nut 140, such that travel in an axial direction of the ball nut 140 along axis A results in linear motion of the extension tube 114, also along axis A (see FIGS. 1A and 1B showing the retracted and the extended positions). The extension tube 114 extends through support assembly 112 and the extrusion cover 108 (see FIG. 3), with the output coupling 144 attached on a distal end of the extension tube 114.

Referring now to FIG. 4, the end stop assembly 128 includes a plurality of washers 132, 134 and 136. The plurality of washers 132, 134 and 136 are attached to the end of the lead screw 54 by a fastener 130. The washer 134 is configured to limit the extension travel of the ball nut 140 (see FIG. 5A) at the distal end 127 of the lead screw 54, thereby preventing the ball nut 140 from disengaging the lead screw 54. The washer 136 is configured to limit the retraction travel of the ball nut 140 (see FIG. 5A). While the illustrated embodiment shows the structure of the end stop assembly 128 to limit the axial travel of the ball nut 140 along axis A, in other embodiments, other structures, mechanisms, or devices sufficient to limit the travel of the ball nut 140 in an axial direction along axis A can be used.

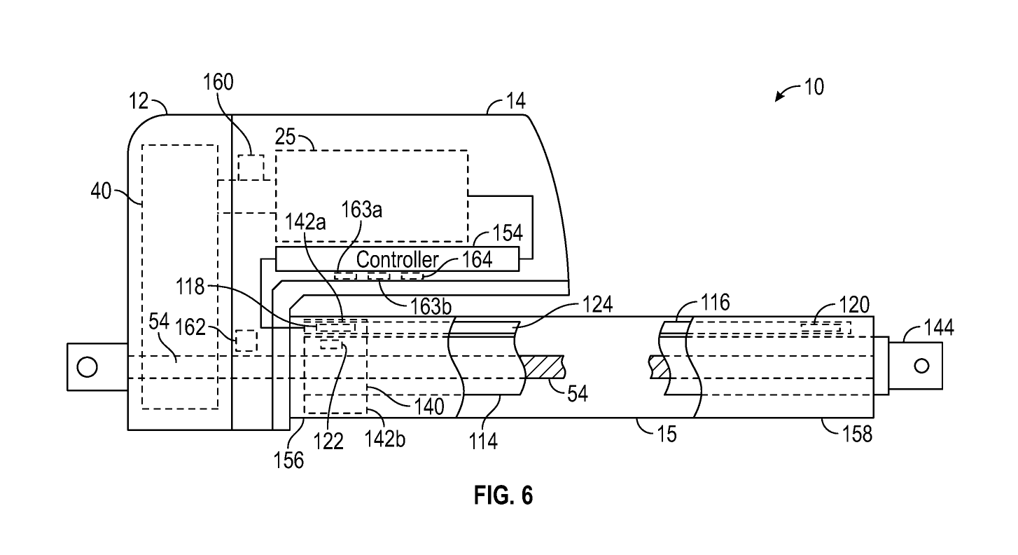

Referring now to FIG. 6, a schematic view of the linear actuator 10 is illustrated. The motor 25 is configured to provide rotational torque to the gear package 40. The gear package 40 is configured to transmit the rotational torque to the lead screw 54. The ball nut 140 engages the lead screw 54 and travels in an axial direction along the lead screw 54 while being supported by the guide elements 142a and 142b, thereby converting the rotational torque of the lead screw 54 to linear thrust. The linear thrust is transmitted from the ball nut 140 to the extension tube 114 and output coupling 144.

Referring now to FIGS. 1C, 1D, 1E, 6 and 7, the linear actuator 10 includes various feedback devices such as the first, second and third limit systems 116, 216 and 316, a digital sensor assembly 160, an analog sensor assembly 162, shunt resistors 163a, 163b and a temperature sensor 164. Additionally, the linear actuator 10 includes a controller 154 disposed on the printed circuit board 75. The controller 154 is configured to control the operation of the motor 25, partially in response to the various feedback devices and therefore the rotation of the lead screw 54. The controller 154 is in electrical connection with the motor 25, the first and second limit systems 116, 216, the digital sensor assembly 160, the analog sensor assembly 162, the shunt resistors 163a, 163b, and the temperature sensor 164.

Referring now to FIG. 1C, the digital sensor assembly 160 is configured to determine the rotational velocity of the motor shaft 30. The digital sensor assembly 160 includes a gear 166 and a rotation sensor 168. The gear 166 is disposed on the motor shaft 30, thus the gear 166 rotates in conjunction with the motor shaft 30. The rotation sensor 168 is configured to record each rotating pass of the gear 166, thus the rotation velocity of the motor shaft 30 can be determined. From the rotational velocity of the motor shaft 30, the rotational velocity of the lead screw 54 can be calculated, and also the axial velocity the output coupling 144 (see FIG. 6) can be determined. Additionally, the acceleration of the rotation of the motor shaft 30, the acceleration of the rotation of the lead screw 54 and the axial travel of the output coupling 144 can be calculated. Finally, the axial position of the output coupling 144 can be determined.

Referring again to FIG. 1C, the analog sensor assembly 162 is configured to determine the position of the output coupling 144 in an axial direction (see FIG. 6) in relation to the extrusion housing 15, for example, when the output coupling 144 is in the retracted position. The analog position assembly 162 includes a gear 170, a shaft 172, and a sensor element 174. The gear 170 is configure to engage the second threaded portion 176 of the lead screw 54 (see FIG. 4), thus the gear 170 rotates in conjunction with the rotation of the lead screw 54. The gear 170 is connected to the shaft 172 that protrudes into the sensor element 174. The sensor element 174 is configured to record the rotational position of the shaft 172. From the rotational position of the shaft 172, the axial velocity of the output coupling 144 can be calculated. Further, the acceleration of both the rotation of the lead screw 54 and axial travel of the output coupling 144 can be determined.

Referring now to FIG. 1D, the printed circuit board 75 includes the shunt resistors 163a and 163b. The shunt resistors 163a and 163b are configured to facilitate measurement by the controller 154 of the current drawn by the motor 25. The shunt resistors 163a and 163b are disposed on a first side 77 of the printed circuit board 75. Additionally, the shunt resistors 163a and 163b are positioned in a parallel electrical configuration, such that the shunt resistors 163a and 163b are able to handle double the current without failure.

Referring now to FIG. 1E, the printed circuit board 75 includes the temperature sensor 164. The temperature sensor 164 is configured to record the temperature of the linear actuator 10 within the front and rear housings 14, 12 (see FIGS. 1A, 1B, and 1C). The temperature sensor 164 is disposed on a second side 79 of the printed circuit board 75, in proximity to the motor 25 (see FIG. 1C).

Referring now to FIG. 6, the first limit system 116 is configured to limit the stroke length of the output coupling 144. The regulation of the stroke length of the output coupling 144 is accomplished by utilizing the first and second magnetic read switches 118, 120 and the magnet 122. In operation, as the ball nut 140 travels in an axial direction along the lead screw 54 (see FIG. 4), the magnet 122 engages the first and second magnetic reed switches 118, 120. When the ball nut 140 approaches a retracted position as shown in FIG. 1A, the magnet 122 is detected by the first magnetic reed switch 118. Upon detecting the magnet 122, the magnetic reed switch 118 sends a signal to the controller 154 indicating the position of the ball nut 140. The controller 154 then turns off power and dynamically brakes the motor 25. Similarly, when the ball nut 140 approaches an extended position, as shown in FIG. 1B, the magnet 122 is detected by the magnetic reed switch 120. Upon detecting the magnet 122, the magnetic reed switch 120 sends a signal to the controller 154 indicating the position of the ball nut 140. The controller 154 then turns off power and dynamically brakes the motor 25. The second limit system 216 operates in a similar manner with the exception that the signal from the reed switch does not operate to turn off the motor 25. Instead, the signal is directed to an external customer application (not shown) to advise that the output coupling 144 has reached the end of the stroke and will shut off.

Referring again to FIG. 6 and as discussed above, the first limit system 116 is configured to indicate the position of the ball nut 140 at the extremes of the linear travel. In a similar manner, the optional second limit system 216 is also configured to indicate the position of the ball nut 140 at the extremes of the linear travel, thereby providing signals to a customer that the output coupling 144 has reached the end of travel. The optional third limit system 316 can be used to indicate the position of the ball nut 140 at predetermined locations as set by the customer. It will be appreciated again, however, that the linear actuator 10 may include the first, second and third limit systems 116, 216, 316, or any other combination of limit systems, including only the first limit system 116.

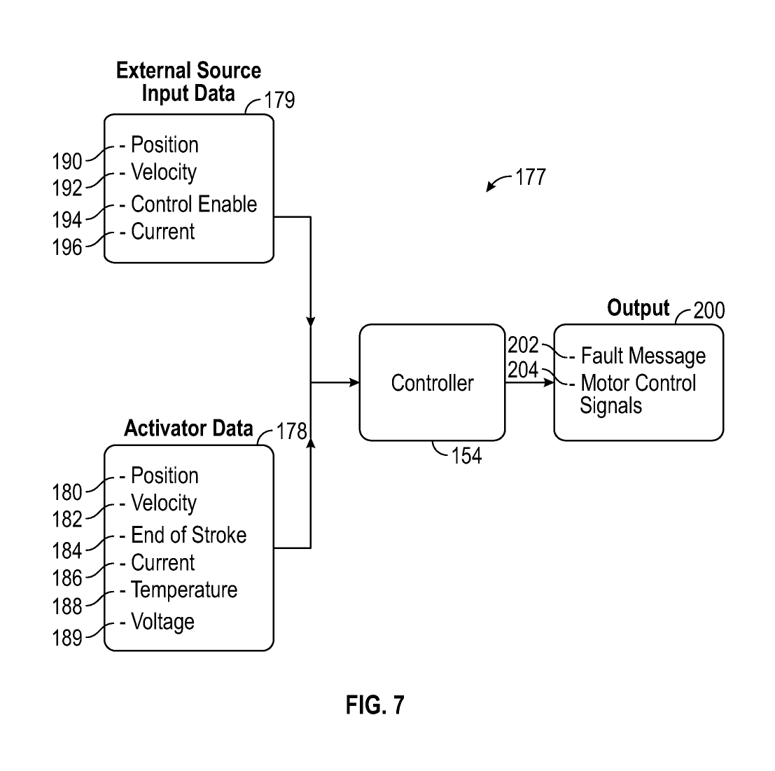

Referring now to FIG. 7, the controller 154 may accept communications from a source external to the linear actuator 10. In one non-limiting example, the controller 154 may be in electrical communication with an application controller (not shown), which is under the control of a user. Various communication protocols are available for use with the controller 154 and the external source, such as the non-limiting examples of J1939 and LIN. Logic within the controller 154 can be configured to power the motor 25 (see FIG. 1C) and to induce the position of the workpiece as required by the external source. Upon reaching the required position, the controller 154 communicates with the external source that the required position of the workpiece has been achieved.

Referring now to FIG. 7, a control system 177 is formed from input from external sources 179, data collected from sensors positioned within the linear actuator 10, the controller 154 and output 200 provided to the motor. Non-limiting examples of input from external sources 179 include work piece position 190, velocity 192, control enable 194 and electrical current 196. The inputs from the external sources 179 are programmed into the controller 154 and may be updated or changed via an external input device. Non-limiting examples of external input devices include laptop computers and the like.

Referring again to FIG. 7, the controller 154 can be configured to continuously monitor data 178, on a real time basis, from the variety of sensors disposed within the linear actuator 10 to effectively operate the linear actuator 10. For example, the first limit system 116, the digital sensor assembly 160 and the analog sensor assembly 162 can provide position, velocity, acceleration and end of stroke data, the shunt resistors 163a, 163b can provide electrical current data and the temperature sensor 164 can provide temperature data.

Referring again to FIG. 7, if during the operation of the linear actuator 10 any actuator data 178 falls outside of external source inputs 179 or falls outside of internal protection limits, to prevent damage the controller 154 may output 200 a fault message 202 to the external source and/or send motor control signals 204 to the motor 25 (see FIG. 6) to correct or terminate performance. For example, the controller 154 may be programmed with an external source input 179 that restricts maximum thrust based upon the current 184 drawn by the motor 25. Other potential preprogrammed external source inputs 179 may include: a maximum motor shaft 30 rotational velocity as recorded via the digital sensor assembly 160; a maximum lead screw 54 rotational position as recorded via the analog position sensor assembly 162; a maximum current as recorded via the shunt resistors 163a, 163b; a maximum temperature as recorded via the temperature sensor 164. It will be appreciated that in other embodiments, other external source inputs 179 and different combinations of external source inputs 179 may be included. It will also be appreciated that the linear actuator 10 may include other mechanisms, structures, devices, components and system sufficient to control operation of the linear actuator 10.

While the illustrated embodiment of the linear actuator 10 is shown to include the feedback components including the first limit system 116, the digital sensor assembly 160, the analog sensor assembly 162, the shunt resistors 163a, 163b, and the temperature sensor 164 within the control system 177, it will be appreciated that in other embodiments not all of the feedback components need to be included and different combinations of feedback components may be included.

Advantageously, the control system 177 and accompanying wiring are contained within the rear housing 12, front housing 14, and extrusion member 15 of the linear actuator 10, thus reducing customer control and wiring requirements. This advantageously reduces both development time and cost.

Advantageously, the linear actuator 10 includes benefits from added efficiency, such as more thrust, higher speed, and lower current while maintaining duty cycles. It will be appreciated that some embodiments may only include a single benefit, while other embodiments may include any combination of benefits depending on the feedback component options possessed by the specific embodiment. Additionally, a standardized retracted length L₃ of the linear actuator 10 (see FIG. 1A), regardless of control option combination possessed by the specific embodiment, further reduces cost, especially as control requirements change; thus, providing greater flexibility and cost savings to the customer.

Advantageously, the linear actuator 10 includes a standardized communication and control structure as discussed above, thus reducing development time across multiple applications. Additionally, the standardized communication and control structure increases the ability of the user to control the linear actuator 10, as the user will be more familiar with the communication and control structure. The standardized communication and control structure includes proprietary J1939 messages that were created to maximize control of the linear actuator 10, while minimizing overall bus traffic. Advantageously, the linear actuator can be controlled by the user, as described above, with the controller 154, via the control system 177, providing operation performance and diagnostic data in a concise manner that can be used by the user to understand how the linear actuator 10 is interacting with external fixtures. In addition, the control system 177 advantageously provides independent load limiting in both axial travel directions via current sensing, rather than a mechanical ball detent clutch. Optional controls include operation with dynamic braking through internal and/or external mechanical end of stroke limit systems; velocity and position control through user logic with analog or digital feedback driven off of the lead screw 54; and total velocity and position.

Finally, the linear actuator 10 includes various gaskets and structures configured to seal the linear actuator 10 from external environment elements typically encountered through use in an application. The various gaskets and structures include the gaskets 16, 104 and 106, the support assembly 112, the rear housing 12, the front housing 14, the extrusion member 15, and the extension tube 114. Optionally, the support assembly 112, rear housing 12, front housing 14, extrusion member 15 and the extension tube 114 can be coated with one or more coatings to protect them from the external environment elements. The coatings can be rated to protect the coated components for at least 200 hours of salt spray.

Collectively, the linear actuator 10 is advantageously configured to meet IP66, IP67, and IP69k environmental standards. The Ingress Protection (IP) rating system is an internationally recognized scale that relates to proven protection against environmental factors such as liquids and solids. The IP 66 standard indicates the linear actuator 10 is both dust tight and protected from powerful jets of water. To test whether the linear actuator 10 is sufficiently dust tight, a vacuum is applied for a duration of up to 8 hours, based on airflow. To test whether the linear actuator 10 is protected from powerful jets of water, the linear actuator is subjected to a test comprising jets of water. Water is projected in powerful jets (12.5 millimeter nozzle) against the linear actuator 10 from all directions. The water is projected for 1 minute per square meter of the linear actuator 10, or at a minimum of 3 minutes. At least 12.5 half liters of water per minute are projected at the linear actuator 10. The water is pressurized at 30 kPA and projected from a distance of 3 meters away from the linear actuator 10.

The IP67 standard indicates that the linear actuator 10 is both dust tight and protected from the effects of short-term immersion in water to a depth between 15 centimeters to 1 meter. As stated above, to test whether the linear actuator 10 is sufficiently dust tight, a vacuum is applied for a duration of up to 8 hours, based on air flow. To test whether the linear actuator 10 is protected from the effects of short term immersion in water to a depth between 15 centimeters to 1 meter, the linear actuator 10 is immersed in water, with two possible positions (1) with the lowest point of the linear actuator being at least 1,000 millimeters below the surface of the water of (2) with the highest point of the linear actuator 10 being positioned at least 150 millimeters below the surface. The position resulting in the deepest immersion of the linear actuator 10 in the water is chosen for the test. The linear actuator 10 is then kept in position under the water for at least 30 minutes.

The IP69k standard indicates that the linear actuator 10 is both dust tight and protected against close-range high pressure, high temperature spray downs. As stated above, to test whether the linear actuator 10 is sufficiently dust tight, a vacuum is applied for a duration of up to 8 hours, based on air flow. To test whether the linear actuator 10 is protected against close-range high pressure, high temperature spray downs, the linear actuator 10 is subjected to a test comprising jets of water. If smaller, the linear actuator 10 is mounted to a turn table and subjected to water projected at a pressure of 8-10 MPa at a distance of 10-15 centimeters away. At least 14-16 liters of water are projected at the linear actuator 10 per minute, with the water temperature being at least 80 degrees. The test lasts for 30 seconds in each of 4 different predetermined angles. If larger, the linear actuator 10 is tested freehand for at least three minutes, with the water being projected from approximately 15-20 centimeters away. The water has all the same properties as discussed above.

The principle and mode of operation of the heavy-duty electro-mechanical linear actuator have been explained and illustrated in the illustrated embodiments. However, it must be understood that the heavy-duty electro-mechanical linear actuator may be practiced otherwise than as specifically explained and illustrated without departing from its spirit or scope.

What is claimed is:

1. A linear actuator comprising:
a housing formed by a front housing, a rear housing and an extrusion housing;
a motor supported within the front and rear housings, the motor including a rotatable output shaft;
a gear package configured to engage the output shaft of the motor such that rotation of the output shaft results in rotation of portions of the gear package;
a lead screw configured to engage the gear package such that rotation of portions of the gear package results in rotation of the lead screw, the lead screw having an external thread;
a nut configured to cooperate with the external thread of the lead screw, the nut further cooperating with the extrusion housing such that rotation of the output shaft of the motor causes travel in an axial direction of the nut relative to the extrusion housing;
an output coupling configured to cooperate with the nut such that travel in an axial direction of the nut causes corresponding travel in an axial direction of the output coupling; and
a control system disposed internal to the housing, the control system including a controller, a plurality of feedback components and a communications network, the controller configured to receive input data from external sources via the communications network and also configured to receive operational data from the plurality of feedback components, the controller further configured to control the motor based on comparisons of the input data from the external sources and the operational data from the plurality of feedback components.

2. The linear actuator of claim 1, wherein seals are formed between the front housing and the rear housing, and between the front housing and the extension housing, and wherein the seals are configured to meet the Ingress Protection (IP) rating of IP66.

3. The linear actuator of claim 1, wherein seals are formed between the front housing and the rear housing, and between the front housing and the extension housing, and wherein the seals are configured to meet the Ingress Protection (IP) rating of IP67.

4. The linear actuator of claim 1, wherein seals are formed between the front housing and the rear housing, and between the front housing and the extension housing, and wherein the seals are configured to meet the Ingress Protection (IP) rating of IP69k.

5. The linear actuator of claim 1, wherein the external sources includes a laptop computer.

6. The linear actuator of claim 1, wherein the communication network is configured to use J1939 communication protocol.

7. The linear actuator of claim 1, wherein the input data received from the external sources is a velocity parameter.

8. The linear actuator of claim 1, wherein the operational data from the plurality of feedback components is a temperature parameter.

9. The linear actuator of claim 1, wherein the operational data from the plurality of feedback components is a velocity parameter.

10. The linear actuator of claim 1, wherein the input data received from the external sources is a control enable parameter.

11. The linear actuator of claim 1, wherein the plurality of feedback components includes a first limit system disposed within the extension housing.

12. The linear actuator of claim 1, wherein the plurality of feedback components includes a second limit system disposed within an interior groove of the extension housing.

13. The linear actuator of claim 1, wherein the plurality of feedback components includes a third limit system configured to provide adjustable positional data.

14. The linear actuator of claim 1, wherein the nut is a ball-type of nut.

15. The linear actuator of claim 1, wherein the lead screw has a cross-sectional profile sufficient to receive a portion of a ball.

16. The linear actuator of claim 1, wherein a brake assembly is mounted concentric to the lead screw and configured to prevent undesirable back-driving of the lead screw.

17. The linear actuator of claim 16, wherein the brake assembly includes a “C” shaped hub configured to engage a portion of the lead screw such that rotation of the “C” shaped hub results in rotation of the lead screw.

18. The linear actuator of claim 17, wherein the “C” shaped hub includes a slot configured to receive corresponding indentations in the lead screw.

19. The linear actuator of claim 1, wherein the output coupling has a maximum extension of 1.0 meters.

20. The linear actuator of claim 1, wherein the output coupling has a maximum thrust rating of 16.0 kilonewtons.
